(19) United States
(12) Patent Application Publication
(10) Pub. No.: US 2016/0381552 A1
(43) Pub. Date: Dec. 29, 2016

(54) HANDLING RISK EVENTS FOR A MOBILE DEVICE

(71) Applicant: QUALCOMM Incorporated, San Diego, CA (US)

(72) Inventor: Bjorn Markus JAKOBSSON, Portola Valley, CA (US)

(21) Appl. No.: 14/750,954

(22) Filed: Jun. 25, 2015

(51) Int. Cl. H04W 12/06; H04M 1/725

(52) U.S. Cl. CPC H04W 12/06; H04M 1/72577; H04W 88/02

(57) ABSTRACT

Disclosed is a mobile device to communicate with a master authority. The mobile device may include a transceiver and a processor. The processor may be configured to determine whether a risk event has occurred at the mobile device. Further, in response to determining that a risk event has occurred, the processor may be configured to attempt to communicate with the master authority to determine whether the mobile device has been reported stolen, and, in response to determining that the mobile device has not been reported stolen, the processor may be configured to allow the mobile device to continue normal operation for a policy duration or until the mobile device enters a secure state.

### BACKGROUND

1. Field

Embodiments relate generally to device security, and, in particular, but not exclusively, relate to handling risk events for a mobile device.

2. Relevant Background

Kill-switch procedures for devices typically rely upon the device owner performing tasks.

For example, as to mobile devices, these tasks may include a user providing a password or personal identification number (PIN) to unlock a mobile device when the user wants to associate with a new network.

Some mobile device owners may use a common password or PIN (e.g., 1234) or store the password or PIN on the device (typically in the address book or written on the back of the device). But these may allow a thief to bypass the security measures to utilize the mobile device on a network.

Kill-switch procedures are often utilized, in which, a high-risk situation occurs (e.g., an anomaly occurs—such as an educational tablet taken off school premises), such that the mobile device is automatically locked, and the mobile device can only be unlocked by proper user authentication—such as the user inputting the correct password or PIN. These types of kill-switch or automatic locking implementations place a large amount of reliance on the mobile device owner performing frequent authentication, such as password inputs. Therefore, improvements for user experience, along with reducing security vulnerability, are desirable.

### SUMMARY

Aspects may relate to a method for handling risk events for a mobile device. The method may include determining whether a risk event has occurred at the mobile device, and, in response to determining that a risk event has occurred, attempting to communicate with a master authority to determine whether the mobile device has been reported stolen. Further, in response to determining that the mobile device has not been reported stolen, the method may allow the mobile device to continue normal operation for a policy duration or until the mobile device enters a secure state.

In one aspect, a mobile device to communicate with a master authority is disclosed. The mobile device may include a transceiver and a processor. The processor may be configured to determine whether a risk event has occurred at the mobile device. Further, in response to determining that a risk event has occurred, the processor may be configured to attempt to communicate with the master authority to determine whether the mobile device has been reported stolen, and, in response to determining that the mobile device has not been reported stolen, the processor may be configured to allow the mobile device to continue normal operation for a policy duration or until the mobile device enters a secure state.

In another aspect, a non-transitory computer-readable medium including code is provided, in which the code, when executed by a processor of a mobile device, causes the processor of the mobile device to: determine whether a risk event has occurred at the mobile device, and, in response to determining that a risk event has occurred, attempt to communicate with a master authority to determine whether the mobile device has been reported stolen. Further, in response to determining that the mobile device has not been reported stolen, code executed by the processor may allow the mobile device to continue normal operation for a policy duration or until the mobile device enters a secure state.

In yet another aspect, a mobile device to communicate with a master authority is disclosed that may include: means for determining whether a risk event has occurred at the mobile device; and, in response to determining that a risk event has occurred, means for attempting to communicate with a master authority to determine whether the mobile device has been reported stolen. Furthermore, in response to determining that the mobile device has not been reported stolen, the mobile device may include means for allowing the mobile device to continue normal operation for a policy duration or until the mobile device enters a secure state.

### BRIEF DESCRIPTION OF THE DRAWINGS

FIG. 1 is a diagram of a mobile device in which embodiments may be practiced.

FIG. 2 is flow diagram illustrating a process to potentially lock a mobile device.

FIG. 3 is diagram illustrating a network environment in which embodiments may be practiced.

FIG. 4 is a diagram illustrating risk events.

FIG. 5 is a diagram illustrating secure states.

FIG. 6 is a diagram illustrating possible states of the mobile device.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the term “mobile device” refers to any form of programmable computer device including but not limited to laptop computers, tablets, smartphones, televisions, desktop computers, home appliances, cellular telephones, watches, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, or any computing device or data processing apparatus.

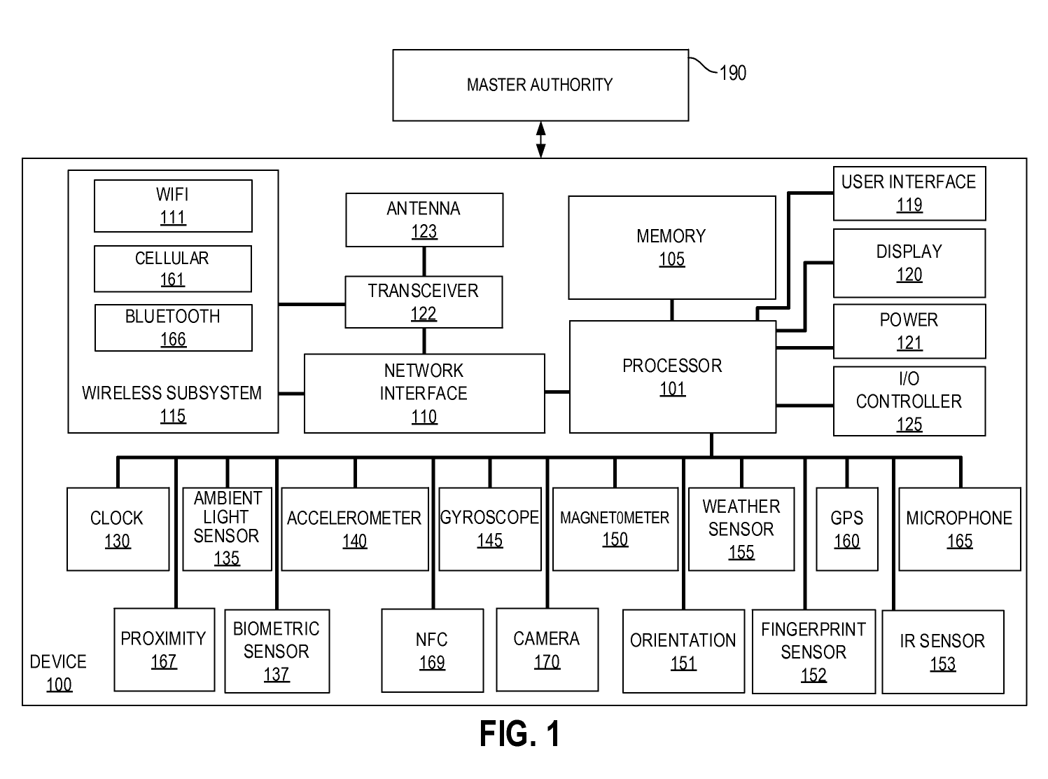

FIG. 1 is block diagram illustrating an exemplary device in which embodiments of the disclosure may be practiced. The system may be a computing device (e.g., a mobile device 100), which may include one or more processors 101, a memory 105, I/O controller 125, and network interface 110. Mobile device 100 may also include a number of sensors coupled to one or more buses or signal lines further coupled to the processor 101. It should be appreciated that mobile device 100 may also include a display 120 (e.g., a touch-screen display), a user interface 119 (e.g., keyboard, touch screen, or similar devices), a power device 121 (e.g., a battery), as well as other components typically associated with electronic devices. In some embodiments, mobile device 100 may be a transportable device, however, it should be appreciated that device 100 may be any type of computing device that is mobile or non-mobile (e.g., fixed at a particular location).

Mobile device 100 may include sensors such as: a clock 130, ambient light sensor (ALS) 135, biometric sensor 137 (e.g., blood pressure monitor, etc.), accelerometer 140, gyroscope 145, magnetometer 150, orientation sensor 151, fingerprint sensor 152, weather sensor 155 (e.g., temperature, wind, humidity, barometric pressure, etc.), Global Positioning Sensor (GPS) 160, infrared (IR) sensor 153, proximity sensor 167, and near field communication (NFC) sensor 169. Further, sensors may include a microphone 165 and camera 170. Communication components may include a wireless subsystem 115 (Bluetooth 166, Wi-Fi 111, cellular 161), which may also be considered sensors, that are used to analyze the environment (e.g., position) of the device. In some embodiments, multiple cameras are integrated or accessible to the device. For example, a mobile device may have at least a front and rear mounted camera. In some embodiments, other sensors may also have multiple installations or versions.

Memory 105 may be coupled to processor 101 to store instructions for execution by processor 101. In some embodiments, memory 105 is non-transitory. Memory 105 may also store one or more programs, models, modules, engines to implement embodiments described below that are implemented by processor 101. Memory 105 may also store data from integrated or external sensors.

Mobile device 100 may include one or more antennas 123 and a transceiver 122. The transceiver 122 may be configured to communicate bidirectionally, via the antenna(s) and/or one or more wired or wireless links, with one or more networks, in cooperation with network interface 110 and wireless subsystems 115. Network interface 110 may be coupled to a number of wireless subsystems 115 (e.g., Bluetooth 166, Wi-Fi 111, Cellular 161, or other networks) to transmit and receive data streams through a wireless link to/from a wireless network, or may be a wired interface for direct connection to networks (e.g., the Internet, Ethernet, or other wired systems). Mobile device 100 may include one or more local area network transceivers connected to one or more antennas. The local area network transceiver comprises suitable devices, hardware, and/or software for communicating with and/or detecting signals to/from wireless application protocols (WAPs), and/or directly with other wireless devices within a network. In one aspect, the local area network transceiver may comprise a Wi-Fi (802.11x) communication system suitable for communicating with one or more wireless access points.

Mobile device 100 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, Advanced LTE, WCDMA, UMTS, 4G, 5G, or GSM. Additionally, any other type of wireless networking technologies may be used, for example, WiMax (802.16), Ultra Wide Band, ZigBee, wireless USB, etc. In conventional digital cellular networks, position location capability can be provided by various time and/or phase measurement techniques. For example, in CDMA networks, one position determination approach used is Advanced Forward Link Trilateration (AFLT).

Thus, device 100 may be a: mobile device, wireless device, cellular phone, personal digital assistant, mobile computer, wearable device (e.g., head mounted display, wrist watch, virtual reality glasses, etc.), internet appliance, gaming console, digital video recorder, e-reader, robot navigation system, tablet, personal computer, laptop computer, or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, mobile device 100 may include a radio device, a cellular telephone device, a computing device, a personal communication system device, or other like movable wireless communication equipped device, appliance, or machine. The term “mobile device” is also intended to include devices which communicate with a personal navigation device, such as by short-range wireless, infrared, wire line connection, or other connection—regardless of whether satellite signal reception, assistance data reception, and/or position-related processing occurs at the device 100. Also, “mobile device” is intended to include all devices, including wireless communication devices, computers, laptops, etc., which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile device.”

It should be appreciated that embodiments of the disclosure as will be hereinafter described may be implemented through the execution of instructions, for example as stored in the memory 105 or other element, by processor 101 of mobile device 100 and/or other circuitry of device and/or other devices. Particularly, circuitry of the device, including but not limited to processor 101, may operate under the control of a program, routine, or the execution of instructions to execute methods or processes in accordance with embodiments of the disclosure. For example, such a program may be implemented in firmware or software (e.g. stored in memory 105 and/or other locations) and may be implemented by processors, such as processor 101, and/or other circuitry of device. Further, it should be appreciated that the terms processor, microprocessor, circuitry, controller, etc., may refer to any type of logic or circuitry capable of executing logic, commands, instructions, software, firmware, functionality and the like. The functions of each unit or module within the mobile device 100 may also be implemented, in whole or in part, with instructions embodied in a memory, formatted to be executed by one or more general or application-specific processors.

Various terminologies will be described to aid in the understanding of aspects of the disclosure. Sensor inputs may refer to any input from any of the previously described sensors, such as: clock 130, ambient light sensor (ALS) 135, biometric sensor 137 (e.g., blood pressure monitor, etc.), accelerometer 140, gyroscope 145, magnetometer 150, orientation sensor 151, fingerprint sensor 152, weather sensor 155 (e.g., temperature, wind, humidity, barometric pressure, etc.), Global Positioning Sensor (GPS) 160, infrared (IR) sensor 153, microphone 165, proximity sensor 167, near field communication (NFC) sensor 169, camera 170, etc.

In particular, some of the sensor inputs may be referred to a biometric sensor inputs from biometric sensors, which may include: fingerprint sensor 152 (e.g., fingerprint input), a touch-screen on display 120 (e.g., fingerprint input), a touch-screen on display 120 (e.g., hand geometry), pressure sensors, microphone 165 (e.g., voice scan), camera 170 (facial scan), IR sensor 153 (iris scan), etc. It should be appreciated these are just example of biometric sensor inputs and biometric sensors and that a wide variety of additional sensor inputs may be utilized. For example, other biometric sensors 137 may be utilized, such as, a blood pressure sensor.

Further, contextual information or contextual inputs may refer to the current environment or current events that the mobile device 100 is currently in as monitored by a “contextual sensor”. Therefore, a contextual sensor may be considered to be any type of sensor that relates to a current context situation. For example, the current context situation may be related to current events of the mobile device that may include such contextual sensing information as: light; acceleration; weather; orientation; location, proximity, sound, etc. Accordingly, examples of contextual sensors may include: ambient light sensor 135; accelerometer 140; weather sensor 155; orientation sensor 151; GPS 160, proximity sensor 167; microphone 165, etc. These merely being examples of context inputs and contextual sensors. Also, contextual inputs may also be characterized as data collected about the user, such as: transaction amounts during purchases, user spending data, crowd source data, demographic data, websites visited, emails, phone calls made, files opened, networks used, applications used, etc.

Embodiments may relate to an apparatus and method to communicate with a master authority 190 to handle risk events and implement a locking procedure on the mobile device 100 based upon the risk events and reports of the mobile device 100 being stolen. In one embodiment, as will be described in more detail hereinafter, mobile device 100, under the control of processor 101, may implement procedures to determine whether a risk event has occurred at the mobile device 100. Further, in response to determining that a risk event has occurred, mobile device 100 under the control of processor 101 may attempt to communicate with the master authority 190 via transceiver 122, and based upon data received from communication with the master authority 190, processor 101 of mobile device 100 may determine if the mobile device 100 has been reported stolen based upon data received from the master authority 190. In response to determining that the mobile device 100 has not been reported stolen, processor 101 of the mobile device 100 may allow the mobile device to continue normal operation for a policy duration or until the mobile device enters a secure state. If processor 101 determines that mobile device 100 has been reported stolen by the master authority 190, then processor 101 may implement a locking procedure to lock mobile device 100. Further, after the expiration of the policy duration, processor 101 may implement a locking procedure for mobile device 100 or may implement a restricted function mode for the mobile device 100. It should be appreciated that the policy duration may be a pre-determined period of time (e.g., 24 hours) set by the master authority 190 or by the mobile device 100.

In one embodiment, in response to determining that attempted communication or contact with the master authority 190 has failed, processor 101 of mobile device 100 may be further configured to: attempt a selected number of communications or contacts with master authority 190, and in response to determining that no communication or contact is made with the master authority 190 after the selected number of attempted communications or contacts, processor 101 may be further configured to lock the mobile device 100 or implement a restricted function mode for the mobile device 100. Further, in one embodiment, in response to determining that the communication or contact with the master authority 190 is successful but the master authority 190 does not provide a response, processor 101 of mobile device 100 may be further configured to attempt a selected number of communications or contacts with master authority 190, and in response to determining that no response is provided from the master authority 190 after the selected number of communications or contacts, the processor 101 of the mobile device 100 may be configured to lock the mobile device or implement a restricted function mode. Examples of these will be discussed in more detail hereinafter.

As will be described in more detailed hereinafter, as one example, a risk event may include at least one of: exiting a pre-designated geo-fenced area, an invalid authentication input, or de-association from a pre-designated network or carrier. A secure state may include at least one of: entering a pre-designated geo-fenced area, a valid authentication input, or association with a pre-designated network or carrier. In some embodiments, a valid authentication input may be required to unlock the mobile device 100. Examples of a restricted function mode may include only master authority contact functions and/or emergency contact functions. Further, in one embodiment, the policy duration (e.g., time durations), locking functions, and/or the restriction function mode may be pre-set for mobile device 100 by master authority 190 or by the mobile device 100 itself.

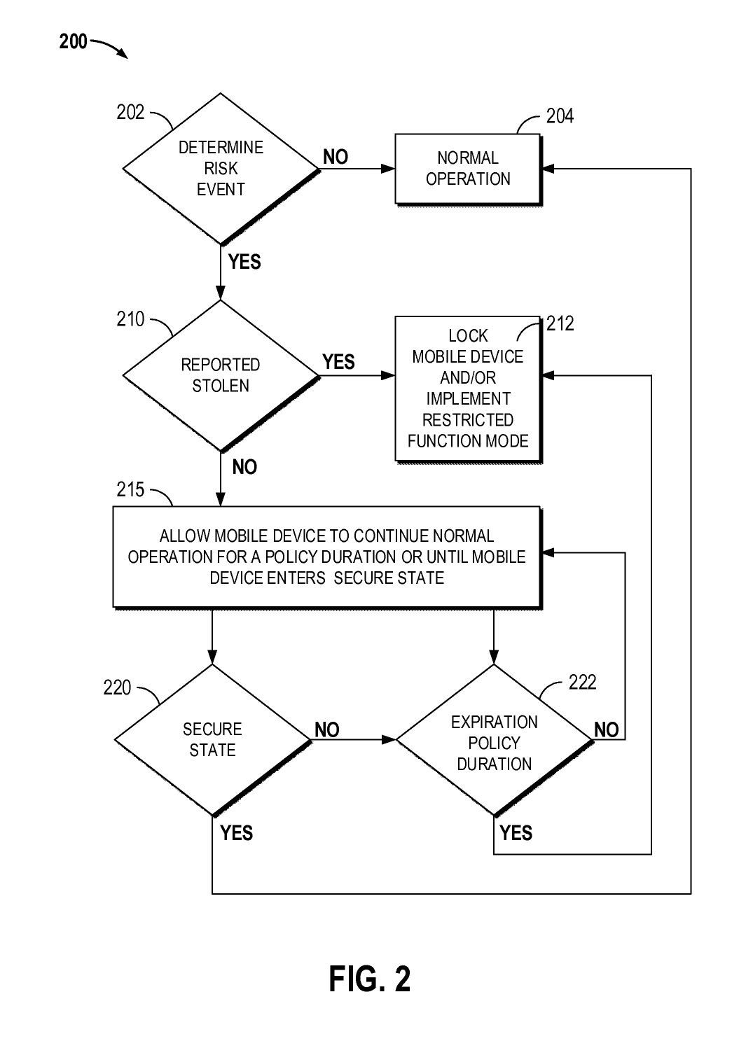

With brief additional reference to FIG. 2, a process 200 to handle risk events and potentially lock a mobile device 100 will be described. In one embodiment, process 200 determines if a risk event has occurred at the mobile device 100 (decision block 202). For example, processor 101 of mobile device 100 may determine if a risk event has occurred. As an example, a risk event monitored for by processor 101 of mobile device 100 may include: exiting a pre-designated geo-fenced area, an invalid authentication input, or de-association from a designated network or carrier. If not, normal operations of the mobile device 100 continue (block 204). However, in response to determining that a risk event has occurred, mobile device 100 may attempt to communicate with master authority 190 to determine whether mobile device 100 has been reported stolen (decision block 210). As an example, under the control of processor 101, in communication with network interface 110 and wireless subsystem 115, mobile device 100 may attempt to communicate via transceiver 122 with the master authority 190 through an appropriate network (e.g., cellular, WiFi, etc.) to determine from the master authority 190 whether mobile device 100 has been reported stolen based upon data received from the master authority 190.

In response to determining that the mobile device 100 has been reported stolen, mobile device 100 may be locked and/or a restricted function mode may be implemented for the mobile device (block 212). However, if a risk event has occurred, and in response to the mobile device 100 not being reported stolen, mobile device 100 may be allowed to continue normal operations for a policy duration or until the mobile device 100 enters a secure state (block 215). As an example, processor 101 of mobile device 100 may allow the mobile device to continue normal operations for the policy duration, which may be a selected period of time that is selected by the mobile device or the master authority 190. For example, if, at decision block 220, mobile device 100 enters a secure state then normal operations continue (block 204). As an example, processor 101 of mobile device 100 may continuously monitor for a secure state to occur for the mobile device which may include: entering a pre-designated geo-fenced area, receiving a valid authentication input, or becoming associated with a designated network or carrier.

If a secure state is not entered (decision block 220) and the policy duration still has not expired (decision block 222) (e.g., a selected time duration, e.g., 24 hours), then mobile device 100 continues normal operation during the policy duration as in block 215. However, if the policy duration expires (e.g., a selected time duration of 24 hours) (decision block 222), and a secure state has never been achieved, then mobile device 100 may be locked and/or a restricted function may be implemented for the mobile device (block 212). Processor 101 of mobile device 100 may implement the locking of the mobile device and/or the restricted function mode. On the other hand, as long as the policy duration has not expired, mobile device 100 may continue normal operations (block 215). Various examples of these functions and their structural implementations will be described in more detail hereinafter.

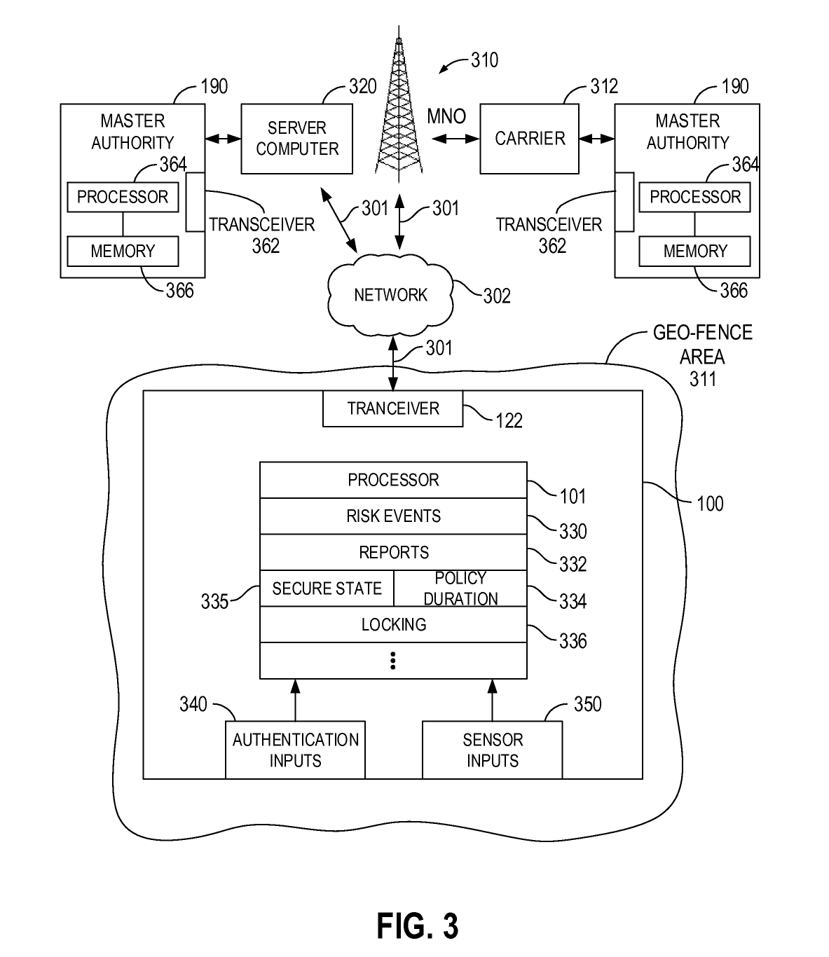

With additional reference to FIG. 3, mobile device 100 via transceiver 122 may be in communication through a network 302 to a server computer 320 (or any type of computing device that performs a service or function) or in a cell phone implementation to a mobile network operator (MNO) 310 and carrier 312 that operate as a cellular service provider. It should be appreciated that either the server computer 320 or the carrier 312 may be coupled to a master authority 190 that can interact with mobile device 100, as previously described. As an example, transceiver 122 may be a wireless based interface (e.g., a transceiver that includes a wireless receiver and transmitter (to receive and transmit data through a link)). As examples, Wi-Fi interfaces, cellular phone interfaces, USB interfaces, wireless modem interfaces, or any type of wireless interface may be utilized. It should be appreciated that any type of wireless, cellular, Wi-Fi etc., communication method from mobile device 100 through wireless links 301 through a wireless network 302 to a server computer 320 and/or a carrier 312 may be utilized. Of course, wired links and wired networks may also be utilized.

In this way, in addition to the mobile device 100 being in communication with a server computer 320 and/or a carrier 312, mobile device 100 may also be in communication with a master authority 190 to determine if the mobile device 100 has been reported stolen based upon data received from communication with master authority 190 via network 302 and links 301. It should be appreciated that server computer 320 may be any type of server system to perform a function or service. Examples may include: on-line stores for purchases, banks for banking purchases, music providers, video providers, particular websites for functions or payments (e.g., hospital sites, government sites, utility sites, etc.), private network sites (e.g., corporate, university, government, etc.). It should be appreciated that these are merely examples and any type of servers, websites, network sites, etc., may be a server computer 320 to which a master authority 190 is associated. Likewise, a master authority 190 may be associated with a carrier 312 for cell-phone and data communication services.

Mobile device 100 via processor 101 may perform risk event functions 330, reporting functions 332, policy duration functions 334, secure state functions 335, locking function 336, etc. Therefore, in communication with a master authority 190, mobile device 100 under control of processor 101 may be configured to: determine if a risk event has occurred via risk event function 330, and if so, may communicate with master authority 190 via transceiver 122 and via network 302. Further, mobile device 100 under control of processor 101 may determine if the mobile device has been reported stolen via reporting functions 332 based upon data received via network 302 through communication with a master authority 190. If so, mobile device 100 under control of processor 101 may implement locking functions 336 based upon acknowledgement from the master authority 190 that the mobile device has been reported stolen.

Additionally, mobile device 100 under the control of processor 101 may determine that a risk event has occurred via risk event function 330 but that the mobile device has not been reported stolen by the master authority 190. In this case, processor 101 may allow mobile device 100 to continue normal operation based upon a selected policy duration functions 334 until it is determined that the mobile device has entered a secure state via secure state functions 335. Otherwise, after the selected policy duration, mobile device 100 may be locked and/or a restricted function mode for the mobile device may be implemented. Various authentication inputs 340 and sensor inputs 350 may be utilized to implement these functions, as will be described in more detail hereinafter. It should be appreciated that master authority 190 may be considered to be a type of a security service provider in association with the server computer 320 and/or carrier 312. Also, it should be appreciated that a master authority 190 may be considered to be a suitable computer system typically including a transceiver 362, a processor 364, and a memory 366, as well as other suitable hardware and/or software to implement its functionality.

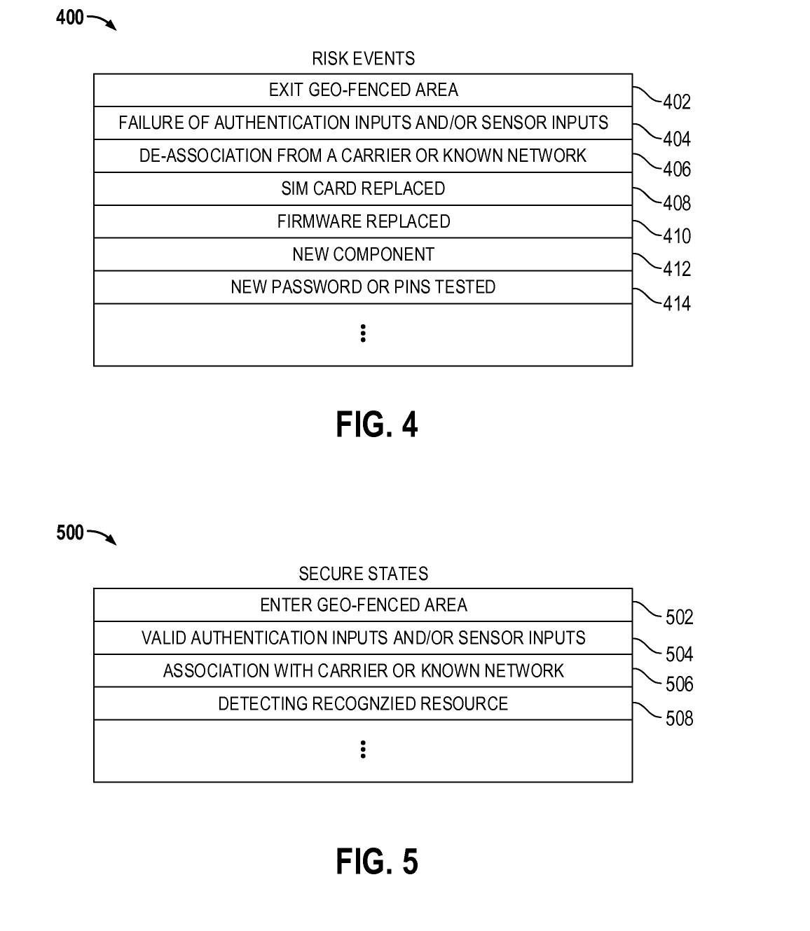

Various examples will be hereinafter described. As one particular example, various types of risk events 400 may be monitored by mobile device 100. Brief additional reference may also be made to FIG. 4 that provides some examples of triggering risk events 400. One example of a triggering risk event may be exiting from a geo-fenced area 402. As an example, if mobile device 100 exits out of geo-fenced area 311 (e.g., FIG. 3) this may indicate that a risk event has occurred. Again, as has been previously described, if mobile device 100 has not been reported stolen by master authority 190, normal operations may be permitted after the exit from the geo-fenced area 311, based upon the selected policy time duration. Once, the mobile device 100 re-enters the geo-fenced area 311, a secure state is re-instated and normal operations continue. However, if a secure state is not re-instated and the selected policy time duration is exceeded, the mobile device 100 may be locked or a restricted function mode enabled for the mobile device 100.

Another example of a triggering risk event may be the failure of authentication inputs and/or sensor inputs 404. As an example, this may occur due to repeated failures of authentication inputs 340 (e.g., user inputted), such as, inputted passwords and/or PINs from the user to a user interface 119 or to a touch-screen on display 120. Other repeated failures of authentication inputs 340 may relate to failed fingerprint inputs from fingerprint sensor 152. Other repeated failures of authentication inputs 340 may include required authentication names, passwords, identifiers, etc., that are vocal inputs to microphone 165. Other repeated failures of authentication inputs 340 may include required scanned facial picture identifiers via camera 170. These failures may provide sufficient evidence that an incorrect user is utilizing the mobile device 100 such that a risk event has occurred.

Further, other sensor inputs 350 such as: GPS locations from GPS sensor 160 indicating unknown or inconsistent locations for the user, accelerometer inputs from accelerometer 140 indicating unknown or inconsistent movement not typical for the user, background camera inputs from the camera 170 indicating unknown or inconsistent facial recognition for the user, background microphone inputs from the microphone 165 indicating unknown or inconsistent voice recognition for the user, background biometric sensor inputs from a biometric sensor 137 (e.g., blood pressure) indicating unknown or inconsistent biometric readings for the user. All of these types authentication inputs 340 (e.g., user inputted) and/or sensor inputs 350 (e.g., background sensor inputs) may be monitored and/or combined and when a threshold is passed a risk event may be determined to have occurred by the mobile device 100. Therefore, these types of inputs may be utilized for continuous background authentication.

It should be appreciated that, in one embodiment, these sorts of sensor inputs 404 may be background inputs as part of background contextual monitoring based upon sensor inputs 350 and may be used in continuous background authentication. These may include a fingerprint scan from a touch-screen on display 120 unknown to the user, a finger geometry scan from a touch-screen on display 120 unknown to the user, a hand geometrical scan from a touch-screen on display 120 unknown to the user, a voice scan from a microphone 165 unknown to the user, a partial facial scan from a camera 170 unknown to the user, etc. Therefore, example sensor devices may include a touch-screen on display 120 (e.g., fingerprint scan, finger geometry scan, hand geometry scan, etc.), microphone 165 (e.g., voice scan), camera 170 (e.g., facial scan), all of which may occur in the background.

Further, contextual sensor inputs may be inputs from sensors related to an event and/or may include at least one of current user input data, previous user input data, websites visited, emails, phone calls, demographic data, etc. Further, a “contextual sensor” may be considered to be any type of sensor that relates to a current context situation. For example, the current context situation may be related to events of the mobile device that may include such sensing information as: light; acceleration; weather; orientation; location; proximity; sound; etc. Accordingly, examples of contextual sensors may include: ambient light sensor 135; accelerometer 140; weather sensor 155; orientation sensor 151; GPS 160; proximity sensor 167; microphone 165; etc. These may all be utilized in the background to determine if the acquired data “is consistent” with the user to determine if a risk event has occurred by the mobile device 100. It should also be noted that another triggering risk event associated with questionable authentication inputs 340 and/or sensor inputs 350 may relate to various anomalous access patterns or evidence of being under attack.

Further, the de-association from a carrier or known network 406 may also be a triggering risk event. As an example, mobile device 100 may exit from it cellular network 302 or its Wi-Fi network 302, either of which may be a triggering risk event.

Additionally, another triggering risk event may be associated with a subscriber identification module (SIM) card of the mobile device 100 being replaced with a SIM card that has not already been approved for use with the mobile device 408. Another example of a triggering risk event may be firmware being replaced or attempting to be replaced 410 in the mobile device 100. Moreover, another triggering risk event may be the mobile device 100 being opened. Yet another triggering risk event may be a new component 412 being introduced internally to the mobile device 100. Another example of a triggering risk event may include the use of “very common” new password or PIN (e.g., 1234, ABC, guest, etc.) 414 that are tested on the mobile device 100, in which these common passwords or PINs have not been utilized by the mobile device owner in the past. Many other types of triggering risk event may also be utilized.

Therefore, a plurality of risk events 400 may be monitored by the mobile device 100. If a risk event 400 has been determined to have occurred, as previously described, the mobile device 100 via the network 302 will communicate with the master authority 190 to determine if the mobile device 100 has been reported as stolen. Accordingly, a risk event 400 acts as a policy-based trigger in order to justify contacting the master authority 190.

Further, if a risk event has occurred, and this trigger has been activated, a new state may be entered, in which, mobile device 100 contacts the master authority 190 through network 302 to determine if the mobile device 100 has been reported as stolen. In an aspect, mobile device 100 may contact the master authority 190 without involving any user action. As previously described, if a connection cannot be made to the master authority 190, then mobile device 100 may try again. As one example, mobile device 100 may attempt a selected number of communications or contacts with master authority 190, and if no communication or contact is made, mobile device 100 may be locked via locking function 336 and/or a restricted function mode for the mobile device may be implemented. As another example, if a communication or connection with the master authority 190 occurs, but the master authority 190 does not provide a response, a selected number of communications or contacts with the master authority 190 may be attempted. If no response is further provided by the master authority 190, mobile device 100 may implement a locking function 336 and/or a restricted function mode for the mobile device may be implemented.

Various types of restriction modes may be implemented. For example, a restriction to the transceiver 122 to not make any connections, except for emergency (x911 calls) and connection attempts to the master authority 190. Thus, emergency and connection attempts to the master authority 190 may be the only type of connections allowed. Also, tracking requests may be allowed. Another example of restriction functions may involve the encryption or removal of selected resources associated with mobile device 100, or the limitations of what applications can be run and what files can be accessed.

Further, the locking function 336 may be based on policy and/or mobile device configurations. Examples of locking functions may include: intentional damage to the mobile device 100 or its components, such as, destruction of the cache or the EEPROM by iterated writing of contents; permanent bricking of the mobile device 100; temporary bricking of the mobile device 100 (e.g., entering locked states that require access to device-specific secrets to undo); secure erasure of storage; etc.

Additionally, as has been previously described, if the master authority 190 responds back to the mobile device 100 via the network 302 that the mobile device 100 is not stolen, mobile device 100 may continue normal operation for a policy duration until the mobile device enters a secure state. As an example, a policy duration may be a time period, such as: 24 hours, 2 days, 3 days, 1 week, etc. After this duration, mobile device 100 may again contact the master authority 190 to determine whether it has been reported stolen. This may continue until the mobile device enters a secure state or the master authority 190 instructs mobile device 100 to enter a secure state.

With brief additional reference to FIG. 5, various examples of secure states 500 will be described. One example 502 of a secure state involves the mobile device 100 entering a geo-fenced area 311 (e.g., FIG. 3). As an example, if mobile device 100 exits out of geo-fenced area 311 this may indicate that a risk event has occurred. As has been previously described, if mobile device 100 has not been reported stolen by master authority 190, normal operations may be permitted after the exit from the geo-fenced area 311, based upon the policy time duration. Once, the mobile device 100 re-enters the geo-fenced area 311, a secure state is re-instated by the mobile device 100 and normal operations may continue.

Another example 504 of a secure state may be a valid authentication input 340 and/or sensor input 350. A valid or correct authentication input 340 may be any of the pre-specified types of authentication inputs previously described. Examples of these valid authentication inputs 340 (e.g., user inputted) may include: correct inputted passwords and/or PINs from the user to a user interface 119 or to a touch-screen on display 120; a correct fingerprint input to the fingerprint sensor 152; a correct vocal input to microphone 165; a correct scanned facial picture via camera 170. Further, continuous background authentication based upon sensor inputs 350 may also be sufficient to authenticate the user, as previously described, alone or in combination, with valid authentication inputs. Examples of sensor inputs 350 may include: GPS locations from GPS sensor 160 indicating known or consistent locations for the user, background camera inputs from the camera 170 indicating known or consistent facial recognition for the user, background microphone inputs from the microphone 165 indicating known or consistent voice recognition for the user, background biometric sensor inputs from a biometric sensor 137 (e.g., blood pressure) indicating known or consistent biometric readings for the user. All of these types authentication inputs 340 (e.g., user inputted) and sensor inputs 350 (e.g., background sensor inputs) may be monitored and/or combined and utilized to authenticate the user.

As previously described, other types of sensor inputs may be background inputs as part of background contextual monitoring based upon sensor inputs 350 and may be used in continuous background authentication. These may include a fingerprint scan from a touch-screen (e.g. via a touch-screen on display 120) unknown to the user, a finger geometry scan from a touch-screen (e.g. via a touch-screen on display 120) unknown to the user, a hand geometrical scan from a touch-screen (e.g. via a touch-screen on display 120) unknown to the user, a voice scan from a microphone 165 unknown to the user, a partial facial scan from a camera 170 unknown to the user, etc. Therefore, example sensor devices may include a touch-screen on display 120 (e.g., fingerprint scan, finger geometry scan, hand geometry scan, etc.), microphone 165 (e.g., voice scan), camera 170 (e.g., facial scan), all of which may occur in the background. Further, contextual sensor inputs may be inputs from sensors related to an event and/or may include at least one of current user input data, previous user input data, websites visited, emails, phone calls, demographic data, etc. Further, a “contextual sensor” may be considered to be any type of sensor that relates to a current context situation. For example, the current context situation may be related to events of the mobile device that may include such sensing information as: light; acceleration; weather; orientation; location; proximity; sound; etc. Accordingly, examples of contextual sensors may include; ambient light sensor 135; accelerometer 140; weather sensor 155; orientation sensor 151; GPS 160; proximity sensor 167; microphone 165; etc. These may all be utilized in the background to determine if the acquired data “is consistent” with the user to determine if the user should be authenticated.

Once the mobile device 100 determines a secure state exists based on valid authentication inputs and/or sensor inputs 504, normal operations of the mobile device 100 may continue.

Further, another type of secure state example 506 may be association with a known carrier or known network. As an example, when the mobile device 100 re-enters its designated cellular network 302 or its Wi-Fi network 302, the secure state is identified by the mobile device 100 and normal operations of the mobile device 100 may continue. Another type of secure state example 508 may be detecting a recognized resource. An example of this may be detecting a specific type of home or corporate router, etc. Once the mobile device 100 determines a secure state exists based on a recognized resource, normal operations of the mobile device 100 may continue.

It should be noted that the user's experience is only affected when the mobile device 100 is locked or restricted, or if the user wishes to transfer ownership, as will be described later. The policies for how and when to restrict access and under what conditions to lock the mobile device 100 are flexible and may be configured by the device owner and/or a proxy, which may be the master authority 190 that the mobile device 100 is associated with. Policies for how to authentic a user requesting to report a mobile device 100 stolen and/or requesting to transfer ownership are also flexible. For example, a master authority 190 may request the user to respond to standard security question(s) or submit a police report to report a mobile device stolen. As another example, the requirements to transfer ownership may involve entering a password and receiving an email at a pre-registered email account, or to provide details from a previous billing statement.

It should be appreciated that an example master authority 190 may include a security service provider company, carriers (e.g. carrier 312), entities associated with a carrier 312, a server computer 320, entities associated with the device owner, insurance companies, etc. It should be noted that the master authority 190 may be part of the server computer 320 or carrier 312 or be an entity associated with the server computer 320 or carrier 312.

Further, a mobile device 100 may have multiple registered master authorities or just one. Additionally, a mobile device 100 may have a pre-configured master authority 190 at the time of being sold, or the user may associate the mobile device 100 with a master authority 190 after the device is initially used (e.g., set-up). Moreover, a user may request a transfer of a mobile device 100 from one master authority 190 to another master authority 190. For example, if the user changes security service providers (e.g., a master authority) or transfers ownership of the device, the associated master authority 190 may be changed. The request to transfer the mobile device 100 to a new master authority 190 may require verification of user identity. Furthermore, various policy matters may be required from both the existing master authority and the new master authority.

The previously described methodology to determine risk events, determine if the mobile device 100 has been reported stolen by a master authority 190, and potentially locking the mobile device 100, provides many beneficial functions. One function is compatibility. The previously described methodology, while requiring network connectivity, does not require network service providers to necessarily support all of the functionality aspects. All that is required is that participating network service providers agree to transmit data packets (whether over Internet Protocol (IP) or Short Message Service (SMS)) from the master authority in order to notify the mobile device 100 of reported stolen activity.

Another function relates to control. The previously described methodology only allows registered security service providers (e.g., a master authorities 190 or associated service providers they serve) to lock mobile devices 100, after the mobile device 100 has been reported stolen by the device owner.

Further, flexibility is provided by the previously described methodology. The previously described methodology allows legitimate users flexibility to use their mobile device 100 without having to authenticate themselves in case of every detected anomaly. The only item required by the user is to report thefts within a reasonable duration of time (e.g., one day, one week, one month, etc.). As to transfer of ownership, the previously described methodology allows the transfer of ownership by only involving a “release” request made by the seller.

Additionally, as to user-proof, the previously described methodology does not rely on user actions for the support of day-to-day activities. In particular, users do not have to be aware of the mobile device 100 and observe every anomalous situation. The mobile device 100 continues normal operations unless reported stolen or after a policy duration of time, in which the mobile device does not return to a secure state.

Moreover, the previously described methodology provides universality by protecting mobile devices 100 registered on networks supporting the functionality, even if an attempt is made to use the mobile device 100 on other networks. Also, being a master authority 190 is an opportunity to provide other services to users, and therefore, is a very low effort operation to run in order to obtain additional services. Fully automated master authorities 190 may be efficiently run to provide additional services and provide higher profit margins.

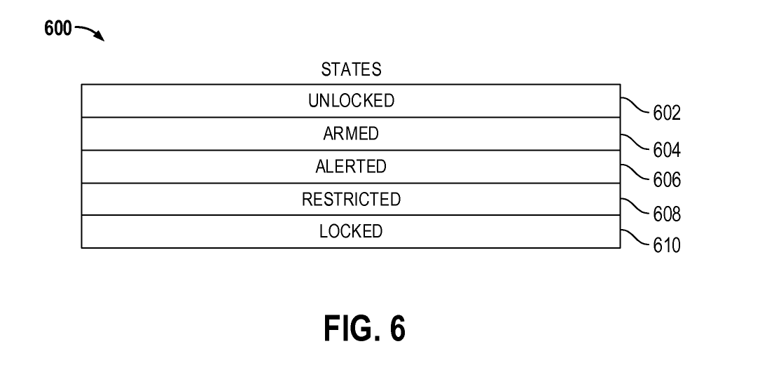

With additional reference to FIG. 6, a description of different states of mobile device 100 will be described. As previously described, each mobile device 100 may be associated with a master authority 190. As an example, the master authority 190 may be an entity, such as, a carrier, that may issue controls or commands for the state of the mobile device, as will be described hereinafter, and, may further issue leases, as also will be described hereinafter. However, it should be appreciated that the master authority 190 may be associated with any type of service providing computing device.

As an example, as shown in FIG. 6, each mobile device 100 may be in one of five states 600: unlocked 602; armed 604; alerted 606; restricted 608; and locked 610. A mobile device 100 may be commanded to be unlocked 602 by the master authority 190 to permit the permanent transfer of service from one network to another (e.g., if the legitimate owner sells the mobile device 100). An unlocked mobile device 100 can be associated with a new master authority 190. While unlocked, the mobile device 100 may accept any SIM cards, and may add corresponding phone numbers to its set of leases. When a mobile device 100 is unlocked, all of its stored leases may be erased.

The normal state of a mobile device is armed 604. An armed state means that the master authority 190 can issue a command to lock the mobile device 100 if it is reported stolen. When a user associates a new SIM card with an armed mobile device 100, the mobile device 100 may determine whether the new phone number is associated with an existing lease. The set of existing leases may be stored securely on the mobile device. It may also verify that the lease has not expired, where each lease may be associated with an expiration date or an indication that the lease is permanent. This verification may be performed: at boot up; as a phone call is placed or received; as an SMS is sent or received; periodically; or based on a user action. If the phone number of the SIM card is not associated with a lease or is associated with an expired lease, then a lease request may be sent to the master authority 190. Emergency calls may still be possible, but other functionality may be limited.

Another state is the alerted state 606. If a risk event is detected, as previously described, the mobile device 100 may enter an alerted state, in which the mobile device 100 may attempt to connect to the master authority 190 to determine if it should be locked. During the time a mobile device 100 is in an alerted state, it may continue to function normally, or may become restricted, based on policy and observed events.

Another state is the restricted state 608. A restricted mobile device 100 may limit its functionality based on a set policy (e.g., a policy set by the master authority, carrier, server computer, etc.). Examples of such limitation policies may include: blocking network access, except for emergency calls (e.g., x911 calls) and/or communications with the master authority 190; limiting access to some files and applications; and/or transmitting SOS signals to surrounding networks and requesting for such SOS signals to be conveyed to the master authority 190.

Another state is the locked state 610. A locked mobile device 100 may only be used for emergency x911 calls and/or to send and receive data traffic to the master authority 190—such traffic may include requests for and commands to unlock, arm, and track. The master authority 190 may issue a lock request to a mobile device 100 (that it is the master of) that are reachable from its network. It can also issue lock request to devices requesting a lease. The master authority 190 may issue tracking requests to mobile devices 100 that it has locked. The state of the mobile device may be kept on a mobile device's secure memory storage.

As to lease requests, the mobile device 100 may transmit a request for a new lease to the master authority 190 using SMS or using a web request over WiFi or another network. The lease request may be encrypted and authenticated using keys securely stored on the mobile device 100 and tagged using a device-specific identifier. The plain text lease request may contain the new phone number for which a lease request is made. When the master authority 190 receives a lease request, it may determine whether the mobile device 100 has been reported stolen; and, if so, then the lease request may be refused and a lock response may be transmitted to the mobile device 100. Otherwise, the master authority 190 may determine whether the number has been previously associated with the mobile device 100; if so, then a permanent lease may be granted; otherwise a temporary lease (e.g., 30 days) may be granted. The use of temporary leases offers users a window of time (corresponding to the duration of the temporary lease) during which to report a device stolen. All responses may be encrypted and authenticated. The mobile device 100, having received a response, may update its state or lease table accordingly. The response may be sent using either SMS to the new phone number or over the network using standard IP protocols.

As to tracking, the master authority 190 may send tracking requests to locked mobile devices 100, to which the mobile device 100 may respond with its GPS location. The request may be piggybacked with the response to the lease request.

As to user requests, a user of the mobile device 100 may interact with the master authority 190 using any computer. The master authority 190, after verifying the identity of the user, may receive and process requests. Requests may include: 1) lock device—the user may report a mobile device 100 stolen, causing a lock request to be made; 2) carriers, enterprises, etc., may also request the devices associated with them be locked; 3) arm device—a user who has requested that a mobile device be locked may ask to undo this (arm device)—e.g., if the device was later found; and release device; 4) a user may request that a mobile device be unlocked, so that the user can sell it and a buyer may register the device using a preferred network. The carrier may limit the extent to which mobile devices can be unlocked, by conveying an unlock policy to the master authority 190.

It should be noted that a user who has two or more carriers (e.g., one for home and one for a vacation country) may only cause new lease requests when first introducing a new SIM card to the device. When this is happening, a new lease is obtained in the amount of time of a network turnaround period. If a device is introduced in a non-participating network, the mobile device 100 remains in unlocked mode, and therefore, its behavior is backwards compatible. Further, if a mobile device 100 is introduced in a participating network—armed and reported stolen—then it may not be able to be used in any network, whether a network is participating or not, because regular SMS channels are used for lease requests and responses such that the method does not rely on network support.

It should be appreciated that these are merely examples of the previously described embodiments. It should be appreciated that aspects of the disclosure previously described may be implemented in conjunction with the execution of instructions by processors of the devices, such as the mobile device 100 and master authority 190, as previously described. Particularly, circuitry of the devices, including but not limited to processors, may operate under the control of a program, routine, or the execution of instructions to execute methods, modules, or processes in accordance with embodiments of the disclosure. For example, such a program may be implemented in firmware or software (e.g. stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a vehicle device, an aircraft device, an automobile device, a user I/O device, a computer, a wired computer, a fixed computer, a desktop computer, a server, a point-of-sale device, a set-top box, or any other suitable device. These devices may have different power and data requirements

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for handling risk events for a mobile device comprising:
determining whether a risk event has occurred at the mobile device, the risk event including at least one of exiting a pre-designated geo-fenced area or de-association from a pre-designated network or carrier;
in response to determining that a risk event has occurred, attempting to communicate with a master authority to determine whether the mobile device has been reported stolen; and
in response to determining that the mobile device has not been reported stolen, allowing the mobile device to continue normal operation for a policy duration or until the mobile device enters a secure state.

2. The method of claim 1 further comprising, in response to determining that the mobile device has been reported stolen, locking the mobile device.

3. The method of claim 1 further comprising, upon expiration of the policy duration, locking the mobile device or implementing a restricted function mode for the mobile device.

4. The method of claim 1 further comprising:
in response to determining that the communication with the master authority has failed, attempting a selected number of communications with the master authority; and
in response to determining that no communication is made after the selected number of attempted communications, locking the mobile device or implementing a restricted function mode for the mobile device.

5. The method of claim 1 further comprising:
in response to determining that the communication with the master authority is successful and the master authority does not provide a response, attempting a selected number of communications with the master authority; and
in response to determining that no response is provided after the selected number of communications, locking the mobile device or implementing a restricted function mode for the mobile device.

6. The method of claim 1, wherein, a risk event further includes an invalid authentication input.

7. The method of claim 1, wherein, a secure state includes at least one of entering a pre-designated geo-fenced area, a valid authentication input, or association with a pre-designated network or carrier, or any combination thereof.

8. The method of claim 1, wherein, a valid authentication input is required to unlock the mobile device.

9. The method of claim 3, wherein, the restricted function mode includes master authority contact functions and emergency contact functions.

10. The method of claim 1, wherein, locking functions and the policy duration are pre-set for the mobile device by the master authority.

11. A mobile device to communicate with a master authority comprising:
a transceiver; and
a processor configured to:
determine whether a risk event has occurred at the mobile device, the risk event including at least one of exiting a pre-designated geo-fenced area or de-association from a pre-designated network or carrier;
in response to determining that a risk event has occurred, attempt to communicate with the master authority to determine whether the mobile device has been reported stolen; and
in response to determining that the mobile device has not been reported stolen, allow the mobile device to continue normal operation for a policy duration or until the mobile device enters a secure state.

12. The mobile device of claim 11, wherein, in response to determining that the mobile device has been reported stolen, the processor is further configured to lock the mobile device.

13. The mobile device of claim 11, wherein, upon expiration of the policy duration, the processor is further configured to lock the mobile device or implement a restricted function mode for the mobile device.

14. The mobile device of claim 11 wherein:
in response to determining that the communication with the master authority has failed, the processor is further configured to attempt a selected number of communications with the master authority; and
in response to determining that no communication is made after the selected number of attempted communications, the processor is further configured to lock the mobile device or implement a restricted function mode for the mobile device.

15. The mobile device of claim 11 wherein:
in response to determining that the communication with the master authority is successful and the master authority does not provide a response, the processor is further configured to attempt a selected number of communications with the master authority; and
in response to determining that no response is provided after the selected number of communications, the processor is further configured to lock the mobile device or implement a restricted function mode for the mobile device.

16. The mobile device of claim 11, wherein, a risk event further includes an invalid authentication input.

17. The mobile device of claim 11, wherein, a secure state includes at least one of entering a pre-designated geo-fenced area, a valid authentication input, or association with a pre-designated network or carrier, or any combination thereof.

18. The mobile device of claim 11, wherein, a valid authentication input is required to unlock the mobile device.

19. The mobile device of claim 13, wherein, the restricted function mode includes master authority contact functions and emergency contact functions.

20. The mobile device of claim 11, wherein, locking functions and the policy duration are pre-set for the mobile device by the master authority.

21. A non-transitory computer-readable medium including code that, when executed by a processor of a mobile device, the mobile device to communicate with a master authority, causes the processor of the mobile device to:
determine whether a risk event has occurred at the mobile device, the risk event including at least one of exiting a pre-designated geo-fenced area or de-association from a pre-designated network or carrier;
in response to determining that a risk event has occurred, attempt to communicate with the master authority to determine whether the mobile device has been reported stolen; and
in response to determining that the mobile device has not been reported stolen, allow the mobile device to continue normal operation for a policy duration or until the mobile device enters a secure state.

22. The computer-readable medium of claim 21, wherein, in response to determining that the mobile device has been reported stolen, further comprising code to lock the mobile device.

23. The computer-readable medium of claim 21, wherein, upon expiration of the policy duration, further comprising code to lock the mobile device or implement a restricted function mode for the mobile device.

24. The computer-readable medium of claim 21, wherein:
in response to determining that the communication with the master authority has failed, further comprising code to attempt a selected number of communications with the master authority; and
in response to determining that no communication is made after the selected number of attempted communications, further comprising code to lock the mobile device or implement a restricted function mode for the mobile device.

25. The computer-readable medium of claim 21, wherein, a risk event further includes an invalid authentication input.

26. The computer-readable medium of claim 21, wherein, a secure state includes at least one of entering a pre-designated geo-fenced area, a valid authentication input, or association with a pre-designated network or carrier, or any combination thereof.

27. A mobile device to communicate with a master authority comprising:
means for determining whether a risk event has occurred at the mobile device, the risk event including at least one of exiting a pre-designated geo-fenced area or de-association from a pre-designated network or carrier;
in response to determining that a risk event has occurred, means for attempting to communicate with the master authority to determine whether the mobile device has been reported stolen; and
in response to determining that the mobile device has not been reported stolen, means for allowing the mobile device to continue normal operation for a policy duration or until the mobile device enters a secure state.

28. The mobile device of claim 27 wherein, in response to determining that the mobile device has been reported stolen, further comprising means for locking the mobile device.

29. The mobile device of claim 27 wherein, upon expiration of the policy duration, further comprising means for locking the mobile device or implementing a restricted function mode for the mobile device.

30. The mobile device of claim 27 further comprising:
means for determining that the communication with the master authority has failed;
means for attempting a selected number of communications with the master authority;
means for determining that no communication is made after the selected number of attempted communications; and
means for locking the mobile device or implementing a restricted function mode for the mobile device.
